(19) United States
(12) Patent Application Publication
(10) Pub. No.: US 2010/0022792 A1
(43) Pub. Date: Jan. 28, 2010

(54) SYNTHETIC PROCESS FOR CYCLIC ORGANOSILANES

(76) Inventor: Qionghua Shen, Latham, NY (US)

Correspondence Address: HOFFMAN WARNICK LLC, 75 STATE STREET, 14TH FLOOR, ALBANY, NY, 12207, US

(21) Appl. No.: 12/440,605

(22) PCT Filed: Sep. 13, 2007
(86) PCT No.: PCT/US07/78364

§ 371 Date: Mar. 10, 2009

Related U.S. Application Data
(60) Provisional application No. 60/825,644, filed on Sep. 14, 2006.

(51) Int. Cl. C07F 7/08

(52) U.S. Cl. 556/431; 556/464; 556/443

(57) ABSTRACT

A process for preparing a cyclic organosilane using a solvent that promotes ring-closure reactions between an organosilane compound and a dihalo organic compound is disclosed. The ring-closure reactions may form a 4-, 5- or 6-member cyclic organosilane. The process involves a mixture including a dihalo organic compound, an organosilane having at least two functional groups, a solvent and magnesium (Mg). The two functional groups in the organosilane may include halogen, alkoxy or a combination thereof. In the presence of Mg, a Grignard intermediate is formed from the dihalo organic compound in the mixture. The solvent favors intra-molecular or self-coupling reactions of the Grignard intermediate. The intra-molecular or self-coupling reaction promotes ring-closure reaction of the Grignard intermediate to form the cyclic organosilane.

### RELATED APPLICATION

The present application claims the benefit of co-pending provisional application No. 60/825,644, filed on Sep. 14, 2006, which is incorporated herein.

### BACKGROUND

1. Technical Field

The disclosure relates to cyclic organosilanes, for example, silacyclobutanes, silacyclopentanes and silacyclohexanes. More particularly, the disclosure relates to methods of forming four-, five-, and six-member-ring compounds with at least one silicon atom as one of the four-, five- or six-members for forming the ring structures of the cyclic organosilane compounds.

2. Background Art

In the current state of the art, cyclic organosilanes are known to be used as chemical vapor deposition (CVD) precursors, fungicidal intermediates, silane-based drug/intermediates and electron-donors for polymerization of olefins. The cyclic organosilanes may include saturated, unsaturated and aromatic substituted four-, five- or six-member ring structures. Currently known methods for preparing cyclic organosilanes result in low to moderate yield which may range from approximately 30% to approximately 60%. The current methods usually involve multiple steps, for example, di-Grignard intermediates may need to be separately prepared before a coupling step with chlorosilanes to form a cyclic organosilane. Other methods may require separate reaction steps for preparing the starting materials. For example, hydrosilation is conducted between an allylchloride and a corresponding hydridochlorosilanes to form chlorosilane. The chlorosilane subsequently undergoes a coupling reaction in the presence of a Grignard intermediate for a ring closure reaction. Often, separate processes for preparing the starting material or the raw materials for the use in forming cyclic organosilanes are expensive. Therefore, the application of such processes may be limited by the costs of either the raw materials or the process for preparing the starting material or both.

In addition to the multiple process steps and expensive raw materials in the currently known methods, a large amount of solvent, for example, diethyl ether and tetrahydrofuran (THF), is usually required to dissolve/dilute any by-product magnesium salts from the coupling reaction. The solvent used in such processes are usually of low boiling points for the purpose of facilitating ease of distillation. However, the large volume of solvent used presents a need for time consuming distillation to remove the solvent in order to isolate the synthesized cyclic organosilane products from the reaction.

In view of the foregoing, it is desirable to provide a synthetic method or methods that involve fewer process steps, higher synthetic yield, less solvent and greater ease in isolating products of cyclic organosilanes.

### SUMMARY

A process for preparing a cyclic organosilane using a solvent that promotes ring-closure reactions between an organosilane compound and a dihalo organic compound is disclosed. The ring-closure reactions may form a 4-, 5- or 6-member cyclic organosilane. The process involves a mixture including a dihalo organic compound, an organosilane having at least two functional groups, a solvent and magnesium (Mg). The two functional groups in the organosilane may include halogen, alkoxy or a combination thereof. In the presence of Mg, a Grignard intermediate is formed from the dihalo organic compound in the mixture. The solvent favors intra-molecular or self-coupling reactions of the Grignard intermediate. The intra-molecular or self-coupling reaction promotes ring-closure reaction of the Grignard intermediate to form the cyclic organosilane. The following sets out the various aspects of the process.

A first aspect of the present disclosure provides a process for the preparation of cyclic organosilanes comprising reacting an organosilane compound with a dihalo organic compound in the presence of magnesium (Mg) in a solvent, wherein the solvent favors intra-molecular reactions.

A second aspect of the present disclosure provides a cyclic organosilane compound obtained by reacting an organosilane compound with a dihalo organic compound in the presence of magnesium (Mg) in a solvent, wherein the solvent favors intra-molecular reactions.

A third aspect of the present disclosure provides a process for the preparation of a cyclic organosilane, the cyclic organosilane having a ring structure comprising at least four members, one of the at least four members being a silicon (Si) atom, the process comprising reacting an organosilane with a dihalo organic compound in the presence of magnesium (Mg) in a solvent, wherein the solvent has a long molecular chain as backbone and favors intra-molecular reactions.

The illustrative aspects of the present disclosure are designed to solve one or more of the problems herein described and/or one or more other problems not discussed.

### DETAILED DESCRIPTION

An embodiment of a process for preparing a cyclic organosilane using a solvent that promotes ring-closure reactions between an organosilane compound and a dihalo organic compound is disclosed. The ring-closure reaction occurs in the presence of a Grignard reagent formed from the dihalo organic compound and magnesium (Mg). The cyclic organosilane formed from the ring-closure reaction may be a ring structure including four, five or six members. The cyclic organosilane includes at least one silicon atom as one of the four, five or six members in the ring structure. The ring structure of the cyclic organosilane may also include one or more unsaturated bond therein.

The organosilane compound may include a carbosilane or a siloxane. Each of the carbosilane and siloxane may include at least two functional groups. The two functional groups may include halogen, alkoxy or a combination thereof.

The organosilane compound may have a general formula:

RR′SiXY

where R is: H, alkoxy, alkyl, phenyl, vinyl or allyl;

R′ is: H, alkoxy, alkyl, phenyl, allyl, vinyl or any group inert to Grignard reagents;

X is halogen and alkoxy (OR″);

Y is: halogen and alkoxy (OR″); and

where R″ is: methyl (Me) or ethyl (Et).

Alternatively, the organosilane compound may be a carbosilane having a general formula:

XR′RSiCH₂SiRR′X

where R is: hydrogen (H), Me, Et or vinyl;

R′ is: H, Me, Et or vinyl;

X is a halogen.

The siloxane compound may have a general formula:

XR′RSiOSiRR′X

where R is: H, Me, Et or vinyl;

R′ is: H, Me, Et or vinyl

X is a halogen.

Dihalo organic compounds suitable for an embodiment of the process of current disclosure may generally include, for example, but are not limited to dihalo alkanes, dihalo alkenes, dihalo allyl, dihalo ethers, dihalo silanes and dihalo siloxanes. Examples of a dihalo organic compound may include, but are not limited to: 1-bromo-3-chloropropane, 1,3-dibromopropane, 1,3-dichlorpropane, 3-chloro-2-chloromethyl-1-propene, 2,2-diethoxy-1,3-dichloropropane, 2,2-dimethoxy-1,3-chloropropane, 2-ethoxy- 1,3-dichloropropane, 2-methoxy- 1,3 -dichloropropane, 1 -bromo-4-chlorobutane, 1,4-dibromobutane, 1,4-dichlorobutane, 2,5-dibromohexane, 3,6-dibromo-octane, 4,7-dibromo-decane, 5,8-dibromo-dodecane, 1,4-dichloro-cis-2-butene, 2,5-dichloro-cis-3-hexene, 3,6-dichloro-cis-4-octene, 4,7-dichloro-cis-5-decene, 5,8-dichloro-cis-6-dodecene, α, α′-dichloro-o-xylene, 1,2-dibromo-benzene, 2,3-dibromopropene, 1-bromo-5-chloro-pentane, 1,5-dibromopentane, 1,5-dichloro-pentane, bis(chloroethyl)ether, 2,6-dichloroheptane, 3,7-dichloro-nonane, 4,8-dichloro-undecane, bis(chloromethyl)-1,1,3,3-tetramethyldisiloxane, bis(chloromethyl)dimethylsilane, 2,2′-dichloro-bicyclopentane, 2-chloroethoxychloromethyldimethylsilane.

The solvent that promotes ring-closure reactions of either mono-Grignard or di-Grignard intermediates favors intra-molecular or self-coupling reactions. The tendency for ring-closure of the Grignard intermediates in such a solvent obviates the need for forming Grignard intermediates in a separate reaction step in the preparation of most cyclic organosilanes. Using such a solvent, a dihalo organic compound may be allowed to react directly with an organosilane compound in a single-step reaction. The single-step reaction may produce a cyclic organosilane at a yield as high as 90%. However, there are exceptions where the single-step reaction process is altered. Alternatives to this single-step reaction process are discussed in later paragraphs of this disclosure.

The solvent may be selected from a group of solvents having long chain molecular structures that favor intra-molecular reactions. The long chain molecular structure includes a minimum of six carbon (C) atoms and a minimum of 2 oxygen (O) atoms. Such solvent may be a diglyme, alternatively known as bis(2-methoxyethyl) ether or glycol dimethyl ether, such as dialkyl diglyme. The solvent may include for example, but is not limited to dimethyl diglyme, diethyl diglyme, dipropyl diglyme or dibutyl diglyme. Other solvents may include tetrahydrofuran (THF). One example of a long chain molecular structure is dibutyl diglyme, which is CH₃CH₂CH₂CH₂OCH₂CH₂OCH₂CH₂OCH₂CH₂CH₂CH₃. The long chain molecular structure promotes self-coupling of Grignard intermediates, leading to a high yield of cyclic organosilanes. In the case of an exemplary intermediate ClMgCH₂CH₂CH₂CH₂SiMe₂Cl, in a typical solvent for example, diethyl ether (CH₃CH₂OCH₂CH₃), competition exists between the intra-molecular and inter-molecular reactions. Such a competition leads to a leveled-out distribution in percentage yield of a mixture of organosilane compounds, which includes the cyclic organosilane product, 1,1-dimethyl-1-silacyclopetane. In contrast, the same intermediate, ClMgCH₂CH₂CH₂CH₂SiMe₂Cl in dibutyl diglyme as solvent, forms a higher yield of the same cyclic organosilane compound, 1,1-dimethyl-1-silacyclopentane. This demonstrates that a solvent favoring ring-closure reactions of intermediates improves the percentage yield of cyclic organosilanes.

Besides a high yield of final products in cyclic organosilane, less solvent is required for the ring-closure reaction by using a solvent that promotes ring-closure reactions. For example, using 7 liters of dibutyl diglyme as solvent yields 1 kg of 1,1 -dimethyl-1-silacyclopentane. In the case where diethyl ether is used as the solvent with the same reactants, the same quantity of 1,1-dimethyl-1-silacyclopentane is achieved by having the volume of diethyl ether at least 4 times (e.g., approximately 4×7 liters) that of dibutyl diglyme.

In addition, by-products, for example, salts of Mg, are usually formed in a separate layer from the cyclic organosilane in the solvent, dibutyl diglyme. This allows easy separation of the by-products from the cyclic organosilane. The solvent, dibutyl diglyme, has a significantly higher boiling point (b.p.) than most of the cyclic organosilanes prepared therein. This difference in b.p. allows the distillation of the cyclic organosilane products obtained from the completed reaction process before the temperature of the mixture being distilled reaches the b.p. of the solvent. With complete distillation of the end products of cyclic organosilanes before the b.p. of the solvent is reached, the end products may be isolated without the need to distill off the solvent. As such, process time is saved without the need to wait for the distillation of the solvent. Dibutyl diglyme provides safe handling and usage and may be recycled at up to 100%. These advantages present a reduction in production costs for the preparation of a very wide range of cyclic organosilanes.

The following examples illustrate different types of cyclic organosilane prepared according to an embodiment of a process the invention.

### EXAMPLE 1

### Preparation of 1,1-Dimethyl-1-silacyclobutane

3 g of magnesium (Mg) powder and 5 g of dibutyl diglyme were placed in a 100 ml three-necked round-bottom flask. The flask was equipped with a dropping funnel, a thermometer and a water condenser fitted with a gas inlet supplied with dry nitrogen. 7.85 g of 1-bromo-3-chloropropane and 6.45 g of dimethyldichlorosilane were mixed with 35 g of dibutyl diglyme in the dropping funnel. Several drops of 1,2-dibromoethane were added to the three-necked round-bottom flask to initiate the Grignard reaction. Once the reaction was initiated, the bromochloropropane/silane/dibutyldiglyme mixture was charged and the reaction was stirred magnetically. The mixed raw materials were added very slowly to maintain the reaction at a temperature in the range of approximately 50° C. to approximately 95° C. Alternatively, the temperature is maintained by cooling the reaction with an external cold-water bath. All of the mixed raw materials were added within 60 minutes. The reaction was further stirred at room temperature for 1 hour after the addition of raw materials. The resultant mixture from the reaction was then poured into an ice/water mixture. The organic phase was isolated and dried over anhydrous sodium sulfate for 2 hours. Distillation under reduced pressure yielded approximately 60% to approximately 75% of 1,1-dimethyl-1-silacyclobutane.

### EXAMPLE 2

### Preparation of 1-Methyl-1-vinyl-1-silacyclobutane

3 g of magnesium (Mg) powder and 5 g of dibutyl diglyme were placed in a 100 ml three-necked round-bottom flask. The flask was equipped with a dropping funnel, a thermometer and a water condenser fitted with a gas inlet supplied with dry nitrogen. 7.85 g of 1-bromo-3-chloropropane and 7.05 g of vinylmethyldichlorosilane were mixed with 35 g of dibutyl diglyme in the dropping funnel. Several drops of 1,2-dibromoethane were added to the flask to initiate the Grignard reaction. Once the reaction was initiated, the bromochloropropane/silane/dibutyldiglyme mixture was charged and the reaction was stirred magnetically. The mixed raw materials were added very slowly to maintain the reaction at a temperature in the range of approximately 50° C. to approximately 95° C. Alternatively, the temperature is maintained by cooling the reaction with an external cold-water bath. All of the mixed raw materials were added within 60 minutes. The reaction was further stirred at room temperature for 1 hour after the addition of raw materials. The resultant mixture from the reaction was then poured into an ice/water mixture. The organic phase was isolated and dried over anhydrous sodium sulfate for 2 hours. Distillation under reduced pressure yielded approximately 60% to approximately 75% of 1-methyl-1-vinyl-1-silacyclobutane.

### EXAMPLE 3

### Preparation of 1-Chloro-1-methyl-1-silacyclobutane

3 g of magnesium (Mg) powder and 5 g of dibutyl diglyme were placed in a 100 ml three-necked round-bottom flask. The flask was equipped with a dropping funnel, a thermometer and a water condenser fitted with a gas inlet supplied with dry nitrogen. 7.85 g of 1-bromo-3-chloropropane and 7.5 g of methyltrichlorosilane were mixed with 35 g of dibutyl diglyme in the dropping funnel. Several drops of 1,2-dibromoethane were added to the flask to initiate the Grignard reaction. Once the reaction was initiated, the bromochloropropane/silane/dibutyldiglyme mixture was charged and the reaction was stirred magnetically. The mixed raw materials were added very slowly to maintain the reaction temperature in the range of approximately 50° C. to approximately 95° C. Alternatively, the temperature is maintained by cooling the reaction with an external cold-water bath. All of the mixed raw materials were added within 60 minutes. The reaction was further stirred at room temperature for 1 hour after the addition of raw materials. The resultant mixture from the reaction separated into two phases after standing at room temperature. The top organic phase was isolated. Distillation of the organic phase under reduced pressure yielded approximately 55% to approximately 70% 1-chloro-1-methyl-1-silacyclobutane.

### EXAMPLE 4

### Preparation of 1,1-Dimethyl-1-silacyclopentane

550 g of magnesium (Mg) powder and 400 g of dibutyl diglyme were placed in a 12-liter three-necked round-bottom flask. The flask was equipped with a dropping funnel, a thermometer and a water condenser fitted with a gas inlet supplied with dry nitrogen. 1270 g of 1,4-dichlorobutane and 1290 g of dimethyldichlorosilane were mixed with 6500 g of dibutyl diglyme in the dropping funnel. Several drops of 1,2-dibromoethane were added to the flask to initiate the Grignard reaction. Once the reaction was initiated, the silane/dichlorobutane/dibutyldiglyme mixture was charged through the dropping funnel and the reaction was stirred mechanically. The reaction was cooled by an external cold-water bath. The mixed raw materials were added at a speed to maintain the reaction at a temperature in the range of approximately 50° C. to approximately 95° C. All of the mixed raw materials were added within 4 hours. The reaction was further stirred at room temperature for 2 hours after the addition of the mixed raw materials. The resultant mixture from the reaction was the poured into an ice/water/HCl mixture. The organic phase was isolated and dried over anhydrous sodium sulfate for 2 hours. Distillation under reduced pressure yielded approximately 80% to approximately 90% of 1,1-dimethyl-1-silacyclopentane.

### EXAMPLE 5

### Preparation of 1-Methyl-1-silacyclopentane

3 g of magnesium (Mg) powder and 5 g of dibutyl diglyme were placed in a 100 ml three-necked round-bottom flask. The flask was equipped with a dropping funnel, a thermometer and a water condenser fitted with a gas inlet supplied with dry nitrogen. 6.35 g of 1,4-dichlorobutane and 5.75 g of methyldichlorosilane were mixed with 35 g of dibutyl diglyme in the dropping funnel. Several drops of 1,2-dibromoethane were added to the flask to initiate the Grignard reaction. Once the reaction was initiated, the silane/dichlorobutane/dibutyldiglyme mixture was charged and the reaction was stirred magnetically. The mixed raw materials were added very slowly to maintain the reaction at a temperature in the range of approximately 50° C. to approximately 95° C. Alternatively, the temperature is maintained by cooling the reaction with an external cold-water bath. All the raw materials were added within 60 minutes. The reaction was further stirred at room temperature for 1 hour after the addition of raw materials. The resultant mixture from the reaction was then poured into an ice/water mixture. The organic phase was isolated and dried over anhydrous sodium sulfate for 2 hours. Distillation under reduced pressure yielded approximately 70% to approximately 80% of 1-methyl-1-silacyclopentane.

### EXAMPLE 6

### Preparation of 1-Methyl-1-vinyl-1-silacyclopentane

3 g of magnesium (Mg) powder and 5 of dibutyl diglyme were placed in a 100 ml three-necked round-bottom flask. The flask was equipped with a dropping funnel, a thermometer and a water condenser fitted with a gas inlet supplied with dry nitrogen. 6.35 μg of 1,4-dichlorobutane and 7.05 μg of vinylmethyldichlorosilane were mixed with 35 g of dibutyl diglyme in the dropping funnel. Several drops of 1,2-dibromoethane were added to the flask to initiate the Grignard reaction. Once the reaction was initiated, the silane/dichlorobutane/dibutyldiglyme mixture was charged and the reaction was stirred magnetically. The mixed raw materials were added very slowly to maintain the reaction at a temperature in the range of approximately 50° C. to approximately 95° C. Alternatively, the temperature is maintained by cooling the reaction with an external cold-water bath. All of the mixed raw materials were added within 60 minutes. The reaction was further stirred at room temperature for 1 hour after the addition of raw materials. Then the resultant mixture from the reaction was poured into an ice/water mixture. The organic phase was isolated and dried over anhydrous sodium sulfate for 2 hours. Distillation under reduced pressure yielded approximately 70% to approximately 85% of 1-methyl-1-vinyl-1-silacyclopentane.

### EXAMPLE 7

### Preparation of 1-Chloro-1-methyl-1-silacyclopentane

230 g of magnesium (Mg) powder and 150 g of dibutyl diglyme were placed in a 12-liter three-necked round-bottom flask. The flask was equipped with a dropping funnel, a thermometer and a water condenser fitted with a gas inlet supplied with dry nitrogen. 508 g of 1,4-dichlorobutane and 598 g of methyltrichlorosilane were mixed with 3000 g of dibutyl diglyme in the dropping funnel. Several drops of 1,2-dibromoethane were added to the flask to initiate the Grignard reaction. Once the reaction was initiated, the silane/dichlorobutane/dibutyldiglyme mixture was charged through the dropping funnel and the reaction was stirred mechanically. The reaction was cooled by an external cold-water bath. The mixed raw materials were added at a speed to maintain the reaction at a temperature in the range of approximately 50° C. to approximately 95° C. All of the mixed raw materials were added within 3 hours. The reaction was further stirred at room temperature for 2 hours after the addition of raw materials. The resultant mixture from the reaction separated into two phases after standing at room temperature. The top organic phase was isolated. Distillation of the organic phase under reduced pressure yielded approximately 55% to approximately 70% of 1-chloro-1-methyl-1-silacyclopentane.

### EXAMPLE 8

### Preparation of 1,1-Dimethy-1-silacyclohexane

3 g of magnesium (Mg) powder and 5 g of dibutyl diglyme were placed in a 100 ml three-necked round-bottom flask. The flask was equipped with a dropping funnel, a thermometer and a water condenser fitted with a gas inlet supplied with dry nitrogen. 7.05 g of 1,4-dichloropentane and 6.45 g of dimethyldichlorosilane were mixed with 35 g of dibutyl diglyme in the dropping funnel. Several drops of 1,2-dibromoethane were added to the flask to initiate the Grignard reaction. Once the reaction was initiated, the silane/dichloropentane/dibutyldiglyme mixture was charged and the reaction was stirred magnetically. The mixed raw materials were added very slowly to maintain the reaction at a temperature in the range of approximately 50° C. to approximately 95° C. Alternatively, the temperature is maintained by cooling the reaction with an external cold-water bath. All of the mixed raw materials were added within 60 minutes. The reaction was further stirred at room temperature for 1 hour after the addition of raw materials. The resultant mixture from the reaction was then poured into an ice/water mixture. The organic phase was isolated and dried over anhydrous sodium sulfate for 2 hours. Distillation under reduced pressure yielded approximately 70% to approximately 85% of 1,1-dimethy-1-silacyclohexane.

### EXAMPLE 9

### Preparation of 1,1-Dimethoxy-1-silacyclohexane

3 g of magnesium (Mg) powder and 5 g of dibutyl diglyme were placed in a 100 ml three-necked round-bottom flask. The flask was equipped with a dropping funnel, a thermometer and a water condenser fitted with a gas inlet supplied with dry nitrogen. 7.05 g of 1,4-dichloropentane and 7.61 g of tetramethoxysilane were mixed with 35 g of dibutyl diglyme in the dropping funnel. Several drops of 1,2-dibromoethane were added to the flask to initiate the Grignard reaction. Once the reaction was initiated, the silane/dichloropentane/dibutyldiglyme mixture was charged and the reaction was stirred magnetically. The mixed raw materials were added very slowly to maintain the reaction at a temperature in the range of approximately 50° C. to approximately 95° C. Alternatively, the temperature is maintained by cooling the reaction with an external cold-water bath. All of the mixed raw materials were added within 60 minutes. The reaction was further stirred at room temperature for 1 hour after the addition of raw materials. The resultant mixture from the reaction separated into two phases after standing at room temperature. The top organic phase was isolated. Distillation of the organic phase under reduced pressure yielded approximately 55% to approximately 70% of 1,1-dimethoxy-1-silacyclohexane.

### EXAMPLE 10

### Preparation of 2,2,4,6,6-Pentamethyl-1-oxo-2,4,6-trisilacyclohexane

3 g of magnesium (Mg) powder and 5 g of dibutyl diglyme were placed in a 100 ml three-necked round-bottom flask. The flask was equipped with a dropping funnel, a thermometer and a water condenser fitted with a gas inlet supplied with dry nitrogen. 11.55 g of bis(chloromethyl)tetramethyldisiloxane and 5.75 g of methyldichlorosilane were mixed with 35 g of dibutyl diglyme in the dropping funnel. Several drops of 1,2-dibromoethane were added to the flask to initiate the Grignard reaction. Once the reaction was initiated, the silanes/dibutyldiglyme mixture was charged and the reaction was stirred magnetically. The mixed raw materials were added very slowly to maintain the reaction at a temperature in the range of approximately 50° C. to approximately 95° C. Alternatively, the temperature is maintained by cooling the reaction with an external cold-water bath. All of the mixed raw materials were added within 60 minutes. The reaction was further stirred at room temperature for 1 hour after the addition of raw materials. Then the resultant mixture from the reaction was poured into an ice/water mixture. The organic phase was isolated and dried over anhydrous sodium sulfate for 2 hours. Distillation under reduced pressure yielded approximately 50% to approximately 60% of 2,2,4,6,6-pentamethyl-1-oxo-2,4,6-trisilacyclohexane.

### EXAMPLE 11

### Preparation of 2,2,6,6-tetramethyl-1-oxo-2,6-disilacyclohexane

3 g of magnesium (Mg) powder and 5 g of dibutyl diglyme were placed in a 100 ml three-necked round-bottom flask. The flask was equipped with a dropping funnel, a thermometer and a water condenser fitted with a gas inlet supplied with dry nitrogen. 7.85 g of 1-bromo-3-chloropropane and 10.16 g of 1,3-dichlorotetramethyldisiloxane were mixed with 35 g of dibutyl diglyme in the dropping funnel. Several drops of 1,2-dibromoethane were added to the flask to initiate the Grignard reaction. Once the reaction was initiated, the bromochloropropane/silane/dibutyl diglyme mixture was charged and the reaction was stirred magnetically. The mixed raw materials were added very slowly to maintain the reaction at a temperature in the range of approximately 50° C. to approximately 95° C. Alternatively, the temperature is maintained by cooling the reaction with an external cold-water bath. All the raw materials were added within 60 minutes. The reaction was further stirred at room temperature for 1 hour after the addition of raw materials. The resultant mixture from the reaction was then poured into an ice/water mixture. The organic phase was isolated and dried over anhydrous sodium sulfate for 2 hours. Distillation under reduced pressure yielded approximately 60% to approximately 75% of 2,2,6,6-tetramethyl-1-oxo-2,6-disilacyclohexane.

An alternative embodiment of the process provides for preparing a di-Grignard intermediate by mixing magnesium (Mg) with a dihalo organic compound in a solvent before coupling with an organosilane. The solvent may be, for example, but is not limited to, dibutyl diglyme. The organosilane may be, for example, but is not limited to, a dihalo organosilane, a dialkoxy organosilane or a halo-alkoxy organosilane. This alternative process of preparing a Grignard intermediate before a coupling reaction is used for the preparation of cyclic organosilane where the organosilane compound includes at least one active functional group, for example, but is not limited to, halomethyl (e.g., CH₂Cl). The alternative or modified process may achieve a good yield of the desired products of cyclic organosilanes. The following examples illustrate various types of cyclic organosilane prepared with the alternative embodiment of the process.

### EXAMPLE 12

### Preparation of 1-Chloromethyl-methyl-1-silacyclopentane

3 g of magnesium (Mg) powder and 5 g of dibutyl diglyme were placed in a 100 ml three-necked round-bottom flask. The flask was equipped with a dropping funnel, a thermometer and a water condenser fitted with a gas inlet supplied with dry nitrogen. 6.35 g of 1,4-dichlorobutane was mixed with 35 g of dibutyl diglyme in the dropping funnel. Several drops of 1,2-dibromoethane were added to the flask to initiate the Grignard reaction. Once the reaction was initiated, the 1,4-dichlorobutane/dibutyldiglyme mixture was charged and the reaction was stirred magnetically. The mixed raw materials were added very slowly to maintain the reaction at a temperature in the range of approximately 50° C. to approximately 95° C. Alternatively, the temperature is maintained by cooling the reaction with an external cold-water bath. All of the mixed raw materials were added within 60 minutes. The resultant Grignard reagent was then added to 8.18 g of chloromthylmethyldichlorosilane within 30 minutes. The reaction was further stirred at room temperature for 2 hours after the addition of Grignard reagent. The resultant mixture from the reaction was then poured into an ice/water mixture. The organic phase was isolated and dried over anhydrous sodium sulfate for 2 hours. Distillation under reduced pressure yielded approximately 65% to approximately 80% of 1-chloromethyl-methyl-1-silacyclopentane.

### EXAMPLE 13

### Preparation of 1-Chloropropyl-methyl-1-silacyclopentane

3 g of magnesium (Mg) powder and 5 g of dibutyl diglyme were placed in a 100 ml three-necked round-bottom flask. The flask was equipped with, a dropping funnel, a thermometer and a water condenser fitted with a gas inlet supplied with dry nitrogen. 6.35 g of 1,4-dichlorobutane was mixed with 35 g of dibutyl diglyme in the dropping funnel. Several drops of 1,2-dibromoethane were added to the flask to initiate the Grignard reaction. Once the reaction was initiated, the 1,4-dichlorobutane/dibutyldiglyme mixture was charged and the reaction was stirred magnetically. The mixed raw materials were added very slowly to maintain the reaction at a temperature in the range of approximately 50° C. to approximately 95° C. Alternatively, the temperature is maintained by cooling the reaction with an external cold-water bath. All of the mixed raw materials were added within 60 minutes. The resultant Grignard reagent was then added to 9.58 g of 3-chloropropylmethyldichlorosilane within 30 minutes. The reaction was further stirred at room temperature for 2 hours after the addition of Grignard reagent. The resultant mixture from the reaction was then poured into an ice/water mixture. The organic phase was isolated and dried over anhydrous sodium sulfate for 2 hours. Distillation under reduced pressure yielded approximately 65% to approximately 80% of 1-chloropropyl-methyl-1-silacyclopentane.

Examples 12 and 13 illustrate the use of the dihalo organic compound, 1,-4dichlorobutane to prepare a cyclic organosilane with one or more active functional groups, for example, but is not limited to, for example CH₂Cl. However, other dihalo organic compounds may be used for preparing corresponding cyclic organosilanes with such active functional groups.

In another alternative embodiment, a further modified process provides for ease of separating cyclic organosilane from the solvent. In particular, where the boiling points of both the cyclic organosilane and the solvent, a dialkly diglyme, are very close, the modified process replaces the dialkyl diglyme with tetrahydrofuran (THF) as solvent. The modified process also incorporates having Mg added to the solvent (THF), hereinafter referred to as “reverse Grignard reaction”, as opposed to having the solvent added to Mg powder, hereinafter referred to as “direct Grignard reaction”. The alternative modified process provides a better yield compared to a direct Grignard reaction in a typically used solvent, diethyl ether. In the alternative embodiment of the process, the reverse Grignard reaction is performed by having Mg powder added to the solution of a dihalo organic compound and an organosilane in THF. The following example illustrates this alternative process.

### EXAMPLE 14

### Preparation of 1,1-Diphenyl-1-silacyclopentane

6.35 g of 1,4-dichlorobutane and 12.65 g of diphenyldichlorosilane were mixed with 50 g of tetrahydrofuran in a 100 ml three-necked round-bottom flask. The flask was equipped with a thermometer and a water condenser fitted with a gas inlet supplied with dry nitrogen. A small portion of 3 g magnesium (Mg) powder was added to the reaction flask. Several drops of 1,2-dibromoethane were added to the flask to initiate the Grignard reaction. The reaction was stirred magnetically. Once the reaction was initiated, the reaction temperature was allowed to increase to a range of approximately 50° C. to approximately 95° C. Another portion of Mg powder was added once the reaction temperature started to decrease. All 3 g of Mg powder was added in 6 portions within 60 minutes. Alternatively, the temperature is maintained by cooling the reaction with an external cold-water bath. The reaction was further stirred at room temperature for 1 hour after the addition of all Mg powder. The resultant mixture from the reaction was then poured into an ice/water mixture. The organic phase was isolated and dried over anhydrous sodium sulfate for 2 hours. After removing THF, distillation under reduced pressure yielded approximately 60% to approximately 75% of 1,1-diphenyl-1-silacyclopentane.

The foregoing description of various aspects of the disclosure has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A process for the preparation of cyclic organosilanes comprising:
reacting an organosilane compound with a dihalo organic compound in the presence of magnesium (Mg) in a solvent;
wherein the solvent favors intra-molecular reactions.

2. The process according to claim 1, wherein the solvent has a long molecular chain with at least six carbon atoms and at least 2 oxygen atoms forming the backbone of the long molecular chain.

3 . The process according to claim 2, wherein the solvent is a dialkyl diglyme.

4. The process according to claim 3, wherein the solvent is a dibutyl diglyme.

5. The process according to claim 1, wherein the solvent is tetrahydrofuran (THF).

6. The process according to claim 1, wherein the organosilane compound has a general formula:
RR′SiXY
wherein R represents one selected from a group consisting of: H, alkoxy, alkyl, phenyl, vinyl and allyl,
wherein R′ represents a functional group inert to Grignard reagents;
wherein X represents one selected from a group consisting of: halogen and alkoxy (OR″);
wherein Y represents one selected from a group consisting of: halogen and alkoxy (OR″)
wherein R″ represents one selected from a group consisting of: a methyl group (Me) and ethyl group (Et).

7. The process according to claim 6, wherein the functional group represented by R′ is one selected from a group consisting of: H, alkoxy, alkyl, phenyl, allyl, vinyl, and a combination thereof.

8. The process according to claim 1, wherein the organosilane compound has a general formula:
RR′XSiBSiRR′X
wherein each of R and R′ independently represents one selected from a group consisting of: hydrogen (H), methyl, ethyl and vinyl;
wherein B represents one selected from a group consisting of: oxygen and CH₂; and
wherein X represents a halogen.

9. The process of claim 1, wherein the reacting comprises mixing the dihalo organic compound with magnesium to form a di-Grignard reagent before mixing with the organosilane compound, wherein the organosilane compound includes an active functional group.

10. The process of claim 9, wherein the active functional group is halo-methyl.

11. The process of claim 1, wherein the reacting comprises adding the magnesium to a mixture of organosilane compound and dihalo organic compound in the solvent.

12. A cyclic organosilane compound obtained by reacting an organosilane compound with a dihalo organic compound in the presence of magnesium (Mg) in a solvent,
wherein the solvent favors intra-molecular reactions.

13. The cyclic organosilane compound of claim 12, including a ring structure with at least one silicon atom as a member of the ring structure.

14. The cyclic organosilane compound of claim 13, wherein the ring structure comprises one selected from a group consisting of: four members, five members and six-members.

15. The cyclic organosilane compound of claim 13, wherein the ring structure includes at least one unsaturated bond.

16. The cyclic organosilane compound of claim 15, wherein the ring structure is fused with an aromatic ring, wherein the at least one unsaturated bond is common to the ring structure and the aromatic ring.

17. The cyclic organosilane compound of claim 13, wherein the ring structure includes an aromatic ring substituent at the at least one silicon atom of the ring structure.

18. The cyclic organosilane compound of claim 13, wherein the ring structure includes an oxygen atom.

19. The cyclic organosilane compound of claim 13 including at least one side-chain at one member of the ring structure.

20. A process for the preparation of a cyclic organosilane, the cyclic organosilane having a ring structure comprising at least 4 members, one of the at least 4 members being a silicon (Si) atom, the process comprising:
reacting an organosilane with a dihalo organic compound in the presence of magnesium (Mg) in a solvent,
wherein the solvent has a long molecular chain as backbone and favors intra-molecular reactions.

21 The process according to claim 20, wherein the longer molecular chain comprises at least 6 carbon atoms and at least 2 oxygen atoms.

22. The process according to claim 20 further comprising mixing the dihalo organic compound with magnesium before the reacting.

23. The process according to claim 20 further comprising mixing the organosilane with the dihalo organic compound in the solvent before introducing the magnesium.

24. A cyclic organosliane compound obtained according to the process of claim 22.

25. A cyclic organosliane compound obtained according to the process of claim 23.
